(19) United States
(12) Patent Application Publication
(10) Pub. No.: US 2019/0163794 A1
(43) Pub. Date: May 30, 2019

(54) Contextual Information for Determining Credibility of Social-Networking Posts

(71) Applicant: Facebook, Inc., Menlo Park, CA (US)

(72) Inventors: Jeffrey Matthew Smith, San Francisco, CA (US); Sara Lee Su, San Jose, CA (US); Adam Mosseri, San Francisco, CA (US)

(21) Appl. No.: 15/824,669

(22) Filed: Nov. 28, 2017

(51) Int. Cl. G06F 17/30; G06Q 50/00; H04L 29/08

(52) U.S. Cl. CPC G06F 17/30528; G06F 17/30268; H04L 67/20; G06Q 50/01

(57) ABSTRACT

In one embodiment, a computing system may receive, from a first user device, a request to post content on an online social network. In response, the system may generate contextual information associated with the content. The system may receive a content request from a second user device. The system may determine that the content is to be presented to the second user and send instructions configured to cause the second user device to display the content with an indicator indicating that contextual information is available. Upon detecting a first interest indicator representing that the content is being viewed, the second device may be instructed to transform the indicator into a contextual highlight. Upon detecting a second interest indicator representing user interest in the available contextual information, the second device may display the contextual information.

### BACKGROUND

A social-networking system supporting an online social network may enable its users (such as persons or organizations) to interact with it and with each other through it. Users of the online social network may post a variety of information through the system to be viewed by and shared with other users. A post may include, for example, content generated by a user through the social-networking system (e.g., the user may type in a message in a user interface provided by the social-networking system or share such a message generated by another user of the system) or content from a third-party source. Unfortunately, whether deliberately or unknowingly, a user may at times post information that is not credible or untrue. Misinformation distributed through the online social network may be taken as true by users, resulting in users being misinformed and the online social network becoming a less credible source of information.

### SUMMARY OF PARTICULAR EMBODIMENTS

Particular embodiments described herein relate to systems and methods for addressing concerns relating to the credibility of information posted on a social platform. In particular embodiments, a social-networking system may automatically generate and/or aggregate contextual information related to a post and display the contextual information with the post. Contextual information may include, for example, credibility indicators for the posted content, relevant additional content, relevant statistical information, and any other information that may help a reader contextualize the content. One objective of this feature is to provide a reader with sufficient contextual information relating to a post to enable the reader to make an informed decision as to whether to believe in the posted content. This may be especially useful in a forum, such as an online social network, where “false news” may be posted.

Contextual information that enables users to make credibility determinations may be voluminous, however. To prevent information overload and not detract from the newsfeed content, particular embodiments described herein relate to a user-interface and logic flow for surfacing contextual information to users. The amount of contextual information relating to a post may be voluminous in certain instances, and as such, the manner in which contextual information is presented is non-trivial, especially in embodiments where contextual information is to be presented with posts that are displayed in a succinct format, such as a newsfeed. For example, in a newsfeed format where each post is represented by an image and a few lines of text, related contextual information containing multiple types of information along with images may easily dwarf the newsfeed post. Surfacing such contextual information with each associated post in the newsfeed may, therefore, defeat the newsfeed's purpose of providing a succinct summary of a variety of information so that a reader may quickly browse through the information and identify those of particular interest to the reader. To address this issue, particular embodiments described herein selectively surface different amounts of contextual information based on particular levels of user inactions with a post to avoid information overload.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A-1D illustrate an example user interface for displaying contextual information related to a posted article.

FIGS. 2A-2B illustrate a second example user interface for displaying contextual information related to a posted article.

FIG. 3 illustrates an example method for providing contextual information for content posted on a social networking system.

FIG. 4 illustrates an example network environment associated with a social-networking system.

FIG. 5 illustrates an example social graph.

FIG. 6 illustrates an example computer system.

### DESCRIPTION OF EXAMPLE EMBODIMENTS

One challenge with combating potential “false news” or other non-credible content is the tension between minimizing non-credible content and not limiting free speech. For example, although a forum may make a determination as to what content is credible, filtering out content that has been deemed non-credible may be viewed as stifling free speech. Further, an automated system configured to filter out non-credible content may, unfortunately, have false positives (i.e., the system may incorrectly filter out content that is credible). Thus, instead of acting (e.g., filtering) on its own credibility judgments, particular embodiments of a social networking system (or other types of forums) may empower users with sufficient contextual information for posted content so that the users can make their own determination as to how much weight to afford the posted content.

Relevant contextual information, however, may be voluminous. Not only may different users rely on different types of contextual information to gauge credibility, the credibility of different types of content may be more suitably inferred from different types of contextual information. In addition, content credibility is typically assessed holistically based on considerations of a variety of contextual information so that evidence of credible content may be balanced against evidence of non-credible content. As such, when a social networking system provides users with sufficient amount of contextual information in accordance with particular embodiments, one challenge is to do so in a way that would not overwhelm the user and drown out or distract from the main content of the social networking system, such newsfeeds. This problem is especially challenging for newsfeeds because newsfeeds are designed to provide users with a quick digest of a lot of aggregated content, and therefore presenting voluminous contextual information with newsfeeds may diminish the intended function and benefit of newsfeeds.

Particular embodiments described herein relate to providing contextual information for content shared on a social-networking system (e.g., news, articles, images, videos, etc.) and various user interfaces for presenting such information. Contextual information may include, for example, credibility indicators for the posted content, relevant additional content, relevant statistical information, and any other information that may help a reader understand the context of the content. An objective of particular embodiments is to provide a reader with sufficient contextual information that would allow him/her to make an informed determination as to how credible the content is, while. This may be especially useful in a forum, such as a social network, where “false news” may be posted. Another objective of particular embodiments is to present contextual information in a manner that would not overwhelm readers and/or negatively affect the user interface for presenting the primary content to which the contextual information relates.

In particular embodiments, a social networking system may be configured to provide contextual information for content posted on the system (while a social networking system is described, embodiments described herein may also be applied to other types of content forums, such as blogs and news sites). Depending on the types of content that may be posted on the social networking system, the system may selectively determine which posted content is to be supplemented with contextual information. For example, certain social networking systems may allow users to author content directly through the system. For instance, through a user interface associated with the social networking system (e.g., a web page, an application, etc.), a user may type in a message or upload photos or videos from his/her computing device. Since these types of posts are authored through the system, they may be considered as “native” content. In particular embodiments, the social-networking system may selectively determine that contextual information would not be displayed with such native content since users generally would understand that native content written by individuals are of those individuals' opinions would not treat the native content as authoritative. In other embodiments, the social networking system may also display contextual information with native content so that other users may have some sense of how credible the posting user is. Contextual information for native content may include, for example, the geographic region from which it is posted, the posting user's education, work history, experience, and/or any other suitable information.

In particular embodiments, the social networking system may allow users to post content from third-party sources. For example, through the social networking system, a user may share a link to a web page or other content source. Using the link, the social networking system may retrieve portions of the shared content (e.g., images, videos, texts, etc.) from the third-party source and present the retrieved content in the newsfeeds or other types of message boards of users. Since this type of content originates from a third-party source, they may be considered as non-native or external to the social network system. In particular embodiments, the system may selectively supplement non-native content with contextual information, since content from an entity or organization may give the impression that the content is credible, even though that may not necessarily be the case.

In particular embodiments, when composing a post, the posting user may be shown a preview of the post along with a user interface for providing contextual information for the content that is to be posted. This allows the posting user to examine, at composition time, a preview of the types of contextual information that may be surfaced to viewers. In particular embodiments, the user may only preview the contextual information but may not influence what information is shown or how it is shown. By not allowing the user to influence the contextual information or its presentation, the system may provide users with further assurance that the contextual information is unbiased and not being manipulated. In other embodiments, the user may prioritize the type of information shown. For example, the user may select certain contextual information that is particularly relevant to the posted content to be displayed first.

In particular embodiments, after content has been posted on the social networking system, it may be presented to users (e.g., as an item in a newsfeed) along with a user interface through which related contextual information may be viewed. In particular embodiments, the user interface may be surfaced to users for every post that satisfies one or more predetermined criteria. For example, the user interface may be presented with any post that contains non-native content, such as a link to an external site. As another example, the user interface may be displayed if the system determines that the content's credibility is suspect. For example, the system may check whether certain credibility indicators are satisfied and score the posted content accordingly. For instance, when non-native content is posted, the social networking system may compare the domain or internet address of the third-party source to a predetermined list of known credible sources (e.g., reputable news agencies, the government, etc.). The system may additionally or alternatively check whether the third-party source has a Wikipedia® page, the existence of which may lend support to a conclusion that the content is credible. Additionally or alternatively, the system may try to retrieve information relating to the content's author (e.g., a reputable news reporter, a professor, a known expert in the field, etc.) using Wikipedia® or other online information, and a positive finding of such information may lend support to the content's credibility. Using these and any other credibility indicators, the system may generate a credibility score that represents the likelihood of the content being credible. If the credibility score is sufficiently high (e.g., exceeding a predetermined threshold), the system, in particular embodiments, may conclude that contextual information is not necessary for the particular post and therefore may not surface the user interface for contextual information. On the other hand, if the credibility score is insufficiently high (e.g., failing to exceed a predetermined threshold), the system may conclude that contextual information should be made available to allow viewers to make their respective determinations as to the content's credibility.

In particular embodiments, the threshold criteria for displaying the user interface may be personalized for each individual viewer. For example, based on a viewing user's historical engagement patterns with contextual information, the system may adjust how frequently or likely contextual information is displayed. For instance, if the user frequently engages with contextual information (e.g., clicks on the user interface to view the contextual information), which may be a sign that the user finds such information helpful, the system may lower its threshold requirement for displaying contextual information to that particular user and/or display more contextual information than would otherwise be displayed. On the other hand, if a user rarely engages with contextual information, the system may scale back the displays and only display highly relevant or noteworthy contextual information. Thus, for example, a particular content presented to a first user may be presented with contextual information (or relatively more detail), while the same content presented to a second user may not have any contextual information (or relatively less detail).

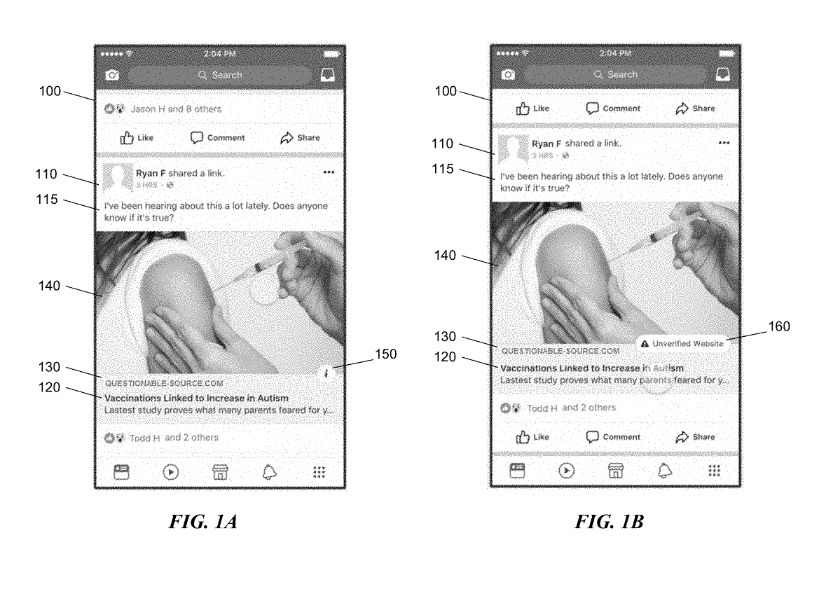

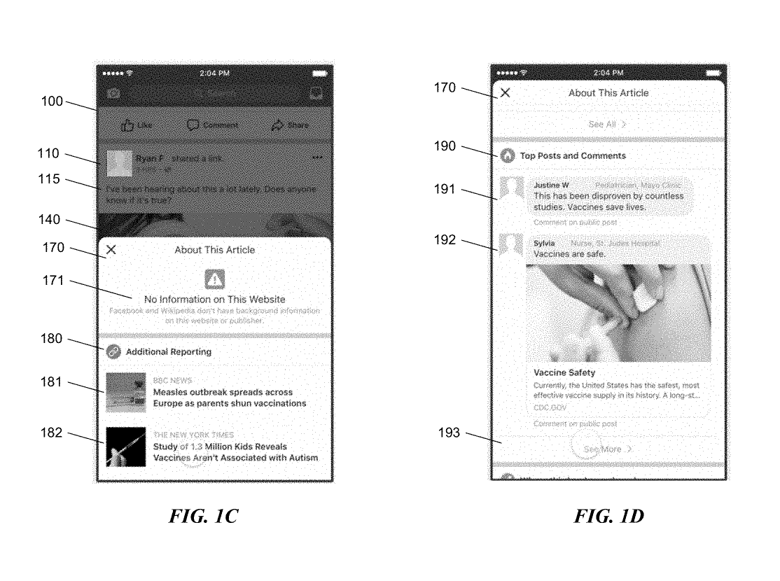

FIG. 1A illustrates an example user interface for displaying contextual information related to a posted content. The example shows a newsfeed 100 that includes a user's post 110 of a shared link to an article from a third-party source. The post 110 may include various content related to the shared link, including the posting user's comment 115, a text snippet 120 of the shared article (e.g., the article's title and the first few lines of text), an source indicator 130 (e.g., the internet domain name from which the article is obtained, the name of the entity or organization that is hosting the article, etc.), and a cover image 140 or video associated with the shared article. The text snippet 120 and the cover image 140 may be retrieved by the social networking system from the third-party source using the shared link.

In particular embodiments, the post 110 may include an indicator for indicating that contextual information is available. An example of such an indicator, as shown in FIG. 1A, is an entry point icon 150, which may be used by a user to access contextual information. In particular embodiments, the entry point icon 150 may be positioned at a border of the cover image 140 so that it partially covers a portion of the cover image 140 and partially covers an area outside the cover image 140. This provides visibility for the entry point icon 150 and clearly shows that the icon 150 is part of the social networking system's user interface and not a component depicted in the cover image 140. Placing the entry point icon 150 partially outside of the cover image 140 has the additional benefit of preventing the third-party source from trying to include a similar icon in the cover image 140 in hopes of confusing users and tricking them to click on the icon to generate click traffic. In addition to displaying the entry point icon 150 with the post 110 in the newsfeed 100, the social networking application may also display the icon 150 when a user follows the shared link (e.g., by clicking on a portion of the post 110) to read the full article. In particular embodiments, when this occurs, the application may retrieve the full article from the external third-party website and display the full article within the application (not shown). The application may overlay the entry point icon 150 over the fully displayed article so that the user may continue to have access to the entry point icon 150 of the contextual information even when reading the full article.

In particular embodiments, the entry point icon 150 may dynamically transform and provide different information depending on a user's current engagement. For example, the entry point icon's 150 default state may not provide any substantive information aside from indicating that contextual information is available for the particular post. An example of the default state of the entry point icon 150 is shown in FIG. 1A. One benefit of having the default state to be as least obtrusive as possible is to avoid overwhelming the users with information and prevent crowding the user's limited display real estate, which is especially scarce on mobile platforms. In particular embodiments, when the social networking application detects that the user is likely viewing the post 110, the entry point icon 150 may transform into a text box to display a short highlight of the available contextual information. Since the user may have only shown interest in the article but has not explicitly indicated a desire to see the contextual information, the application at this stage may simply provide a non-obtrusive contextual highlight to peak the user's interest while avoiding overwhelming the user with information when such information is not of interest.

FIG. 1B illustrates an example where the entry point icon 150 (in FIG. 1A) has transformed to include a contextual highlight 160. The transformation may have been triggered, for example, when the application detects that the content of the post 110 is positioned in the center of the application or when the user is touching or the user's input device (e.g., a mouse) is hovering over a portion of the post 110 (e.g., the snippet 120, source indicator 130, and/or the cover image 140). In particular embodiments, the contextual highlight 160 may display information that likely has relevance to the credibility of the shared content. For instance, the contextual highlight 160 in FIG. 1B shows that the third-party source 130 (i.e., “QUESTIONABLE-SOURCE.COM”) is an unverified website. This may mean that the social networking system has determined that the third-party source 130 is not found in a predetermined list of verified content sources, such as established news channels or media outlet. The contextual highlight 160 may alternatively or additionally indicate the shared article's author (e.g., “Written by John Doe,” along with a profile picture), publisher (e.g., “Published by XYZ News”), source (e.g., “Hosted on XYZ.com”), number of comments/likes/shares/followers on the social networking platform (e.g., “120 k Comments” or “Currently Trending”), or any missing information that is typically expected of credible content (e.g., “Unverified Website”).

Since the limited space of the contextual highlight 160 interface restricts the amount of information that could be presented therein, the social networking system in particular embodiments may select the most significant contextual information (in terms of evidence of credibility or lack thereof) to present as the contextual highlight 160. In particular embodiments, the system may rank the contextual information of the shared article (e.g., known information about the third-party source, author, geographic region, number of followers, etc.) based on a predetermined hierarchy of the relative significance of the different types of contextual information. The following is an example of such a hierarchy of contextual information, listed in order from the most significant to the least significant (whether positive or negative evidence of credibility): the third-party source being from a highly reputable publisher, the third-party source lacking a Wikipedia® page, the author being a reputable reporter, the article's trending status (e.g., the article has been shared over a threshold number of times within a time period), the article being posted from a questionable location or by a user who has been black-listed, etc. Based on this hierarchy, even if an article's author is highly reputable (e.g., based on a predetermined verified list), if the article lacks a type of contextual information that is typically expected of credible sources, such as a Wikipedia® page, then the system may select to display information relating to the missing Wikipedia® page as the contextual highlight 160.

In particular embodiments, the contextual highlight 160 may also be personalized for individual viewers. For example, for content that is reasonably credible, the contextual highlight 160, instead of displaying credibility indicators, may display contextual information that the particular viewer typically finds informative. This determination may be based on the viewer's past engagement data. For instance, the system may have learned that the viewer is historically more responsive or interested in the contextual information when certain types of contextual highlight is displayed (e.g., number of engagements by the viewer's friends, number of times the viewer's friends have shared or viewed the article, particular publishers and/or authors, the lack of certain types of credibility indicators, or any other type of contextual information).

In particular embodiments, once a user has expressed interest in seeing more contextual information, a user interface for presenting contextual information may be surfaced. In particular embodiments, a user may express interest by activating (e.g., by tapping, touching, or clicking) the entry point icon 150 or the contextual highlight 160. Upon detecting such a triggering event, the user may be shown a contextual information interface, which may cover all or a portion of the newsfeed interface. As an example, FIG. 1C shows a contextual information pane 170 that is surfaced on top of the newsfeed 100, covering most of the post 110. In particular embodiments, the top section 171 of the contextual information pane 170 may include more details or an explanation on the surfaced contextual highlight. In the example shown, the top section 171 of the contextual information pane 170, referring to the third-party source that published the shared article, further indicates that there is “No Information on This Website.” This determination may be based on a comparison of the third-party source with a predetermined list of verified content providers and/or by attempting to determine whether background information for the third-party source may be found from a trusted resource, such as Wikipedia®.

In particular embodiments, the contextual information pane 170 may be configured to include multiple modules for displaying different types of contextual information. In particular embodiments, the contextual information pane 170 may have one or more credibility modules, each of which containing information that is relevant for helping a user assess the article's credibility. One example of a credibility module is the aforementioned notice that certain contextual information that is expected to exist for credible sources is in fact missing. This may include, for example, the lack of a web page or Wikipedia® page, unknown publisher or author, etc. As another example of credibility module, FIG. 1C illustrates an “Additional Reporting” module 180, which may include one or more links to other articles similar to the one in question. In particular embodiments, the other articles may be published by trusted sources, such as BBC News 181 and New York Times 182. The social networking system may identify such articles by mapping each article shared through the social networking system (or articles published by the known, trusted sources) to a vector space, in which articles that are more similar would be closer in proximity. A clustering algorithm, such as k-nearest-neighbors, or any other suitable algorithm for identifying semantically similar articles may also be used. These additional sources of information may give the user additional perspectives on the topic covered by the article in question.

FIG. 1D illustrates another example of a credibility module 190 that is configured to display the top public posts and/or comments by other users in response to the article in question. For example, the article shared in the post 110 may have been shared numerous times through the social networking system. After seeing the shared article (or its snippet), users may have responded with other shared posts and comments. In particular embodiments, the social networking system may identify which of those posts and comments may be the most popular or garnered the most attention. For example, the social networking system may make such determination based on the number of user engagements (e.g., “liking,” sharing, reposting, continued commenting, etc.) with the posts and comments. In particular embodiments, the social networking system may also weigh posts/comments that are associated with reputable sources or organizations, especially those that are particular relevant to the topic of the article in question. For example, if the article in question relates to vaccines, posts and comments from hospitals, scientists, or health professions (e.g., the comment 191 and post 192 shown in FIG. 1D) may be given more weight, thereby increasing the likelihood of such posts/comments being surfaced in the credibility module 190. As another example, if the article in question relates to a political topic, comments and posts by government officials (e.g., congressman, governors, etc.), lawyers, and political pundits may be given more weight. In yet another example, if the shared article relates to a particular person, such as a public figure, comments or posts by that public figure or conversation with that public figure may be given more weight. In particular embodiments, the module 190 may, by default, show a predetermined number of comments or posts, but it may provide the user an option to see more comments or posts 193.

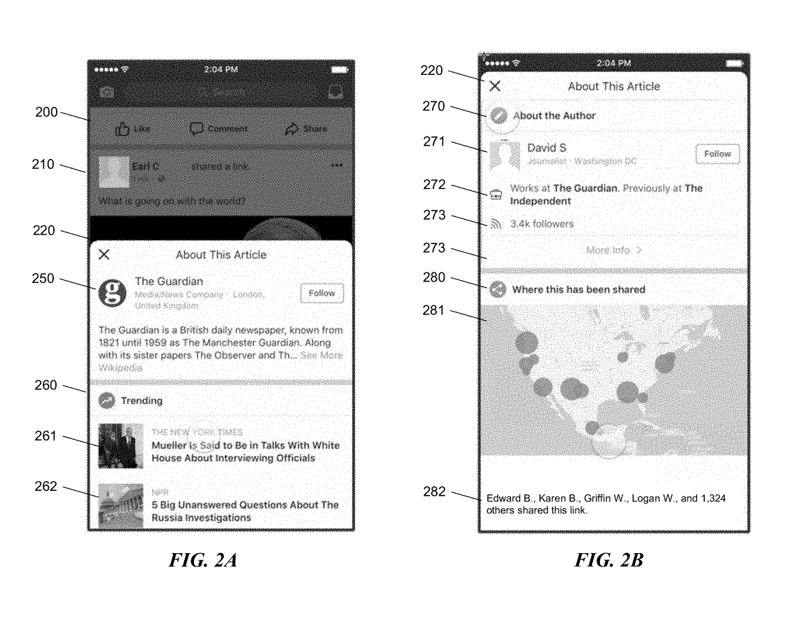

FIGS. 2A-2B illustrate further examples of credibility modules. The example shows a newsfeed 200 that includes a user's post 210 of a shared link to an article, along with a surfaced contextual information pane 220. In the contextual information pane 220, the first credibility module 250 shown indicates that the social networking system has found background information associated with the publisher of the shared article. In particular embodiments, the credibility module 250 may include a logo of the publisher, its name, an entity classification (e.g., media/news company), where it is headquartered, a snippet of its background information (along with an option to see more), and any other suitable background information that may be found. In particular embodiments, the social networking system may retrieve such information using a trusted information source, such as Wikipedia® or a predetermined list of verified sources. For example, the system may extract the internet domain address of the shared link and search for the domain address of the trusted information source. The information returned by the trusted information source may then be processed to extract information of interest (e.g., company location, background information, etc.). In particular embodiments, after the legitimacy of the publisher has been verified using the trusted information source, additional background information relating to the publisher may also be retrieved from its website directly or its social networking profile.

FIG. 2A further shows another credibility module 260 that displays currently trending articles related to the article shared by the post 210, such as articles 261 and 262. As previously described, the social networking system may use a variety of algorithms to identify other articles being shared through the system that are relevant to the shared article in question. To determine which those articles to surface to the user, the system may rank them based on how popular they are (or “trending”) on the social networking system. Popularity may be determined based on the number of user engagements with the articles, as well as the rate of engagements (e.g., five thousand engagements in the last hour). Other factors may also be taken into consideration, such as whether the articles' respective publishers are reputable (e.g., based on a predetermined list of verified publishers), how closely the articles' respective contents are related to the article in question (e.g., based on a k-nearest-neighbors algorithm or distance within the aforementioned vector space, etc.), and any other suitable factors that may bake certain articles more interesting than others. In particular embodiments, other types of reactions or statistical data from the social networking system may be displayed to give the viewing user a sense of what others think about the article. This may include, for example, the number of times the article was shared, the rate at which they were shared, the number of comments made relating to the article, the number of users flagging the article as being “false news,” or any other suitable indicator of the users' overall sentiment towards the article.

FIG. 2B illustrates an example of a credibility module 270 relating to the author of the shared article. In particular embodiments, the social networking system may use the link to the shared article to obtain the article's text, from which the system may extract authorship information. The system may then search for the author, using the extracted information (e.g., name, title, the domain address hosting the article, etc.), on the internet, a trusted source (e.g., Wikipedia®), the social networking system itself, or any other information source. In the example shown, the credibility module 270 may display the author's information 272 (e.g., name, profession, location, etc.), work history 272, and the number of followers 273 on the social networking system. While not shown, the module 270 may also display other information about the author, such as education background, links to other articles by the author, and the author's social-networking posts or comments relating to the same topic as the article being shared. In particular embodiments, the author module 270 may, by default, display a limited amount of information in order not to overwhelm the user. As such, the author module 270 may provide an interface 273 that, upon being triggered, may display additional available information to the user. In particular embodiments, any of the modules may include such a feature to provide additional available information. In particular embodiments, the additional available information may be presented within each module through a scrolling interface that scrolls in a direction perpendicular to the scrolling direction of the modules in the contextual information pane. For example, if the contextual information pane 220 allows a user to scroll through the different modules (e.g., the trending module 260 and the author module 270) vertically, the user interface in the author module 270 for seeing more information about the author may implement a horizontal scrolling interface.

FIG. 2B further illustrates a module 280 that graphically illustrates from where the article in question has been shared. For example, the module 280 may include a geographic “heat” map 281 with indicators that indicate regions from which the article was shared. The indicators may be sized differently to graphically represent the relative number of times the article has been shared from different regions. In addition to the spatial distribution of user interest, the module 280 may also include a time series or any other graphical representation of the users' interest over time (in other words, temporal distribution of interest). The heat map 281 and/or the time series may provide a user with a general sense of the overall distribution of interest across space and time. In addition, such information may also be used by a user to gauge the credibility of the shared article. For example, upon seeing that the geographic location from which the article is mostly shared is in a particular foreign country, even though the article relates to an issue that is particularly relevant to those living in the United States, the user may question the legitimacy of the article. In particular embodiments, the heat map 281 may also present any detected sharing pattern that is atypical. For example, the sharing pattern (e.g., both spatially and temporally) of the article may be compared to a typical sharing pattern of a similar type of article (e.g., political article, health-related article, social article, etc.), and the difference may be displayed on the map to illustrate anomalies. For example, a separate heat map and/or time series showing a typical sharing pattern may be shown next to the heat map 281 and/or time series of the sharing pattern of the article in question to allow the user to draw his/her own conclusion. As another example, the same heat map 281 may display both the sharing pattern of the article in question and the sharing pattern of a typical article, using different color-coded indicators to visually separate the two data types.

In particular embodiments, the contextual information pane may also include a relevant content module for displaying any relevant information that may be of interest to the viewer. Relevant information may include, for example, related content from other sources. For instance, as previously described, the social networking system may determine the article's subject matter or issue and find other related articles from other sources. In particular embodiments, the system may also search for other articles on the same issue or topic (which may be referred to as the “pivot”) but from different perspectives (e.g., different sentiments, political leanings, etc.). In particular embodiments, the content selected to be surfaced may not be polar opposite from the pivot content, but just slightly different, since the viewer may be more receptive of alternative views that are not overly different from the article. Thus, content from neutral sources may be ranked higher during content selection

As described above, the contextual information interface may include a variety of modules. In particular embodiments, the social networking system may personalize the contextual information presented to each individual. For example, modules that a particular user historically likes to engage with (e.g., publisher and heat map modules) may be positioned higher and/or afforded more display real estate. In contrast, modules that the user rarely engages with (e.g., author module and trending module) may occupy less real estate and/or not displayed to that particular user.

In particular embodiments, the order in which the modules appear may be determined based on a personalized ranking of the modules. The modules may be ranked based on a variety of factors. In particular embodiments, the modules may be ranked based on a combination of each module's credibility signal strength (e.g., whether the source is reputable, whether an expected credibility indicator is lacking, etc.), global interest in the module (e.g., whether the type of module is of interest to users of the social networking system as a whole), and individual interest (e.g., whether the type of module is of interest to the particular viewing user). For example, if a credibility signal is particularly strong (e.g., the article lacking an expected credibility indicator, such as a verifiable publisher), it may be surfaced closer to the top of the contextual information interface. As another example, if another article from a reputable source contradicts or may be used to verify the content presented in the article in question, that article from the reputable source may be ranked higher. As yet another example, if the article's credibility is sufficiently strong (e.g., the article is from a reputable source and authored by a reputable author), the modules with contextual information that the viewer would likely find interesting would be surfaced closer to the top (e.g., relevant trending articles, the heat map, etc.). In particular embodiments, whether a particular user is likely to be interested in a module may be based on user profile information, past behavior signals (e.g., whether the user historically engages with that type of module), political leaning, topical interests, and any other information relating to the user.

In particular embodiments, based on historical engagement patterns of a viewer, the system may learn, using any suitable machine learning or statistical modeling, which type of contextual information the user finds most persuasive. For example, over time, the system may detect that the user typically engages with or spends more time looking at particular types of modules. As another example, for each module displayed to the user, the system may determine whether the module lends credibility support to the associated article or not. Using this information, the system may detect whether the user's engagement with the article (e.g., the user sharing the article may be used as a signal that the user finds the article sufficiently credible) is influenced by particular types of contextual information. For example, if the user consistently shares an article despite a particular module indicating that the article is not credible (e.g., lacking a verified author), it may be a sign that the user does not find that module persuasive as a credibility indicator. On the other hand, if the user's sharing pattern often coincides with whether a particular module supports or not supports the article's credibility (especially when other modules may indicate otherwise), the system may determine that the user finds the type of contextual information provided by that module persuasive. Based on this determination, the system may surface the trusted type of modules closer to the top of the contextual information interface.

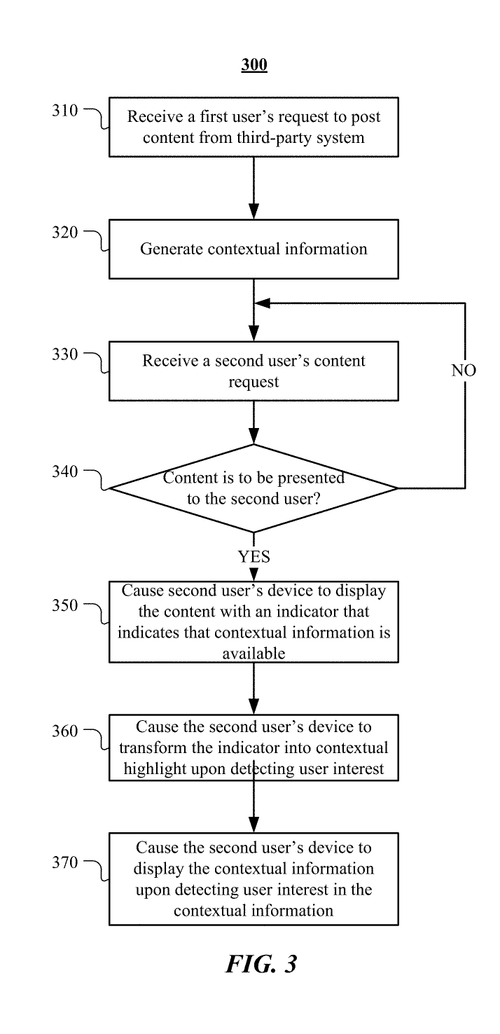

FIG. 3 illustrates an example method 300 for providing contextual information for content posted on a social networking system. The method may begin at step 310, where the social networking system may receive a post from a computing device (e.g., a mobile phone, a laptop, a computer) associated with a user of the online social network. The post, for example, may include a link to an article or any other content hosted by a third-party system. The user may have entered the link through a user interface provided through a social-networking application installed on the user's device or through a web page of the social networking system. Alternatively, the user may have submitted the post by re-sharing another post or a link to the article that he/she saw on a page of the social-networking system (e.g., on the user's newsfeed, a friend's wall or bulletin board, etc.). The post may alternatively have been submitted through a third-party application that uses an API of the social networking system to submit the post.

At step 320, the social networking system may generate, in response to the request to post, contextual information associated with the content. In particular embodiments, the contextual information may comprise information indicative of the credibility of the content. For example, the contextual information may include one or more credibility indicators retrieved from the third-party system, including, for example, information relating to the content's author and publisher. The contextual information may also include one or more second credibility indicators generated by the social networking system, including, for example, trending, sharing, or commenting information on the social networking system, information about the content's publisher or author retrieved from other sources, indications that certain credibility indicators expected of credible content are missing, and any other suitable information that would help a user assess the credibility of the content. In particular embodiments, contextual information may also include other posts of content that are related to the content in question (e.g., content on the same subject matter or issue posted by other third-party sources). For example, the system may determine the posted content's subject matter or issue, and identify related content posted on the social networking system that is associated with the subject matter or issue. The social networking system may also determine a perspective expressed in the posted content relating to the subject matter or issue, and identify another content posted on the online social network that expresses a different perspective relating to the subject matter or issue. These types of other posts of content may also serve as contextual information.

In particular embodiments, contextual information may also include a heat map that identifies the spatial distribution of users who have shared or engaged with the posted content. To generate the map, the system may, in particular embodiments, retrieve records of instances of the posted content being shared by users of the online social network. The system may identify the geographic locations associated with those users who have shared the content and generate the heat map to depict the identified geographic locations. In particular embodiments, a temporal distribution of when those users shared the posted content may also be included in the contextual information.

At step 330, the system may receive a content request from a second device associated with a second user of the online social network. For example, the request may be the second user requesting a newsfeed or wall posts. In response, the social networking system may determine, at step 340, whether the content from the third-party system is to be presented to the second user. If not (e.g., due to the fact that the first user who posted the content is too far removed in the social graph from the second user), then the system may continue to wait for other content requests that would result in the posted content being presented.

If the system determines that the posted content is to be presented to the second user, the system may send instructions configured to cause the second user's device to perform various operations. For example, at step 350, the system may cause the second user's device to display the content (e.g., as part of the requested newsfeed) with an indicator. The indicator, such as the entry point icon shown in FIG. 1A, may indicate that contextual information is available for the content. In particular embodiments, whether the indicator is displayed or made available to the second user may depend on whether he/she has enabled the feature and/or whether he/she is likely to engage with contextual information, which may be determined based on the second user's profile information and/or historical engagement patterns with contextual information on the social networking system.

At step 360, upon detecting a first interest indicator representing that the content is being viewed on the second device (e.g., the user's cursor hovers over a portion of the displayed content or the displayed content is in the center of the screen, etc.), the second user's device may, in accordance with instructions from the system (e.g., JavaScript embedding in the HTML sent from the system), transform the indicator into a contextual highlight, such as the one shown in FIG. 1B. The contextual highlight may be based on a portion of the contextual information. For example, if the system has determined that the contextual information lacks a credibility indicator expected of credible contents, the contextual highlight may present information that indicates that the credibility indicator is lacking for the content. In scenarios where the contextual information includes more than one credibility indicator, the system may select which one to display as the contextual highlight. For example, for each credibility indicator (e.g., author and/or publisher being reputable, publisher lacking a Wikipedia® page, the content trending on the social networking system, the heat map appearing abnormal, etc.), the system may generating a score that represents a level of significance of the credibility indicator in indicating whether the content is credible. The score, for example, may be based on a predetermined weight assign to each type of credibility indicator. The scores may then be used to rank the credibility indicators. In particular embodiments, the highest ranking credibility indicator may then be displayed as the contextual highlight. In particular embodiments, the system may further take into consideration which of the credibility indicators is most likely to be of interest to the viewing user. As previously described, the system may make such determination based on the viewing user's profile information or past engagement patterns retrieved from a database of the social networking system.

At step 370, upon detecting a second interest indicator representing user interest in the available contextual information (e.g., the user tapping, clicking, or hovering over the entry point icon), the system may cause the second user's device to display the contextual information. As previously described, the contextual information may include a variety of modules, which may be ranked to determine their display order.

Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for providing contextual information, including the particular steps of the method of FIG. 3, this disclosure contemplates any suitable method for providing contextual information, including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

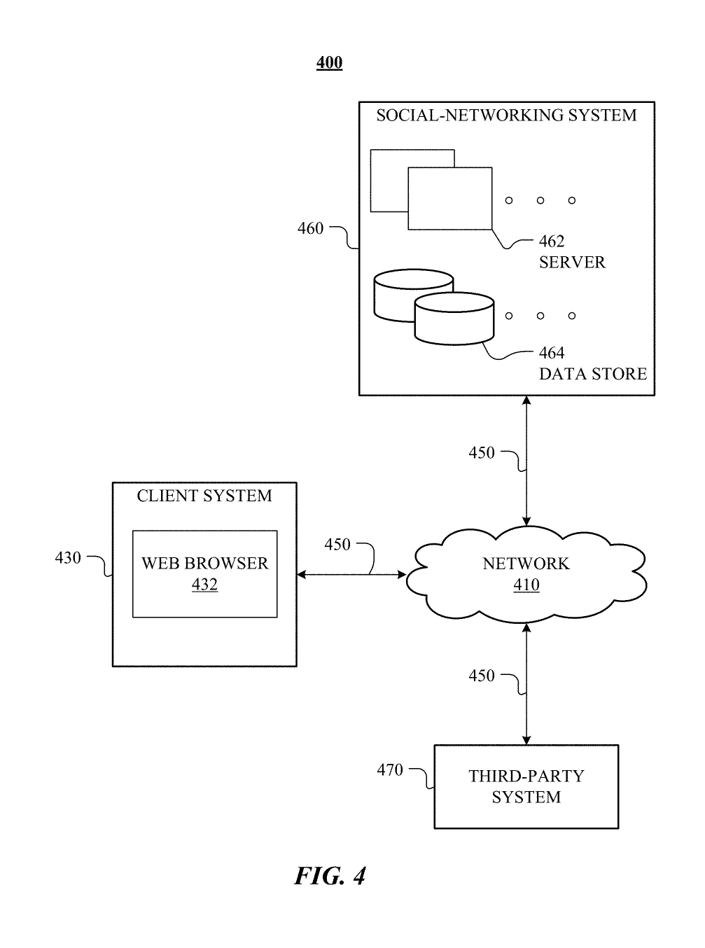

FIG. 4 illustrates an example network environment 400 associated with a social-networking system. Network environment 400 includes a client system 430, a social-networking system 460, and a third-party system 470 connected to each other by a network 410. Although FIG. 4 illustrates a particular arrangement of client system 430, social-networking system 460, third-party system 470, and network 410, this disclosure contemplates any suitable arrangement of client system 430, social-networking system 460, third-party system 470, and network 410. As an example and not by way of limitation, two or more of client system 430, social-networking system 460, and third-party system 470 may be connected to each other directly, bypassing network 410. As another example, two or more of client system 430, social-networking system 460, and third-party system 470 may be physically or logically co-located with each other in whole or in part. Moreover, although FIG. 4 illustrates a particular number of client systems 430, social-networking systems 460, third-party systems 470, and networks 410, this disclosure contemplates any suitable number of client systems 430, social-networking systems 460, third-party systems 470, and networks 410. As an example and not by way of limitation, network environment 400 may include multiple client system 430, social-networking systems 460, third-party systems 470, and networks 410.

This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 may connect client system 430, social-networking system 460, and third-party system 470 to communication network 410 or to each other. This disclosure contemplates any suitable links 450. In particular embodiments, one or more links 450 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 450 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 450, or a combination of two or more such links 450. Links 450 need not necessarily be the same throughout network environment 400. One or more first links 450 may differ in one or more respects from one or more second links 450.

In particular embodiments, client system 430 may be an electronic device including hardware, software, or embedded logic components or a combination of two or more such components and capable of carrying out the appropriate functionalities implemented or supported by client system 430. As an example and not by way of limitation, a client system 430 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 430. A client system 430 may enable a network user at client system 430 to access network 410. A client system 430 may enable its user to communicate with other users at other client systems 430.

In particular embodiments, client system 430 may include a web browser 432, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 430 may enter a Uniform Resource Locator (URL) or other address directing the web browser 432 to a particular server (such as server 462, or a server associated with a third-party system 470), and the web browser 432 may generate a Hyper Text Transfer Protocol (HTTP) request and communicate the HTTP request to server. The server may accept the HTTP request and communicate to client system 430 one or more Hyper Text Markup Language (HTML) files responsive to the HTTP request. Client system 430 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 460 may be a network-addressable computing system that can host an online social network. Social-networking system 460 may generate, store, receive, and send social-networking data, such as, for example, user-profile data, concept-profile data, social-graph information, or other suitable data related to the online social network. Social-networking system 460 may be accessed by the other components of network environment 400 either directly or via network 410. As an example and not by way of limitation, client system 430 may access social-networking system 460 using a web browser 432, or a native application associated with social-networking system 460 (e.g., a mobile social-networking application, a messaging application, another suitable application, or any combination thereof) either directly or via network 410. In particular embodiments, social-networking system 460 may include one or more servers 462. Each server 462 may be a unitary server or a distributed server spanning multiple computers or multiple datacenters. Servers 462 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 462 may include hardware, software, or embedded logic components or a combination of two or more such components for carrying out the appropriate functionalities implemented or supported by server 462. In particular embodiments, social-networking system 460 may include one or more data stores 464. Data stores 464 may be used to store various types of information. In particular embodiments, the information stored in data stores 464 may be organized according to specific data structures. In particular embodiments, each data store 464 may be a relational, columnar, correlation, or other suitable database. Although this disclosure describes or illustrates particular types of databases, this disclosure contemplates any suitable types of databases. Particular embodiments may provide interfaces that enable a client system 430, a social-networking system 460, or a third-party system 470 to manage, retrieve, modify, add, or delete, the information stored in data store 464.

In particular embodiments, social-networking system 460 may store one or more social graphs in one or more data stores 464. In particular embodiments, a social graph may include multiple nodes—which may include multiple user nodes (each corresponding to a particular user) or multiple concept nodes (each corresponding to a particular concept)—and multiple edges connecting the nodes. Social-networking system 460 may provide users of the online social network the ability to communicate and interact with other users. In particular embodiments, users may join the online social network via social-networking system 460 and then add connections (e.g., relationships) to a number of other users of social-networking system 460 to whom they want to be connected. Herein, the term “friend” may refer to any other user of social-networking system 460 with whom a user has formed a connection, association, or relationship via social-networking system 460.

In particular embodiments, social-networking system 460 may provide users with the ability to take actions on various types of items or objects, supported by social-networking system 460. As an example and not by way of limitation, the items and objects may include groups or social networks to which users of social-networking system 460 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 460 or by an external system of third-party system 470, which is separate from social-networking system 460 and coupled to social-networking system 460 via a network 410.

In particular embodiments, social-networking system 460 may be capable of linking a variety of entities. As an example and not by way of limitation, social-networking system 460 may enable users to interact with each other as well as receive content from third-party systems 470 or other entities, or to allow users to interact with these entities through an application programming interfaces (API) or other communication channels.

In particular embodiments, a third-party system 470 may include one or more types of servers, one or more data stores, one or more interfaces, including but not limited to APIs, one or more web services, one or more content sources, one or more networks, or any other suitable components, e.g., that servers may communicate with. A third-party system 470 may be operated by a different entity from an entity operating social-networking system 460. In particular embodiments, however, social-networking system 460 and third-party systems 470 may operate in conjunction with each other to provide social-networking services to users of social-networking system 460 or third-party systems 470. In this sense, social-networking system 460 may provide a platform, or backbone, which other systems, such as third-party systems 470, may use to provide social-networking services and functionality to users across the Internet.

In particular embodiments, a third-party system 470 may include a third-party content object provider. A third-party content object provider may include one or more sources of content objects, which may be communicated to a client system 430. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 460 also includes user-generated content objects, which may enhance a user's interactions with social-networking system 460. User-generated content may include anything a user can add, upload, send, or “post” to social-networking system 460. As an example and not by way of limitation, a user communicates posts to social-networking system 460 from a client system 430. Posts may include data such as status updates or other textual data, location information, photos, videos, links, music or other similar data or media. Content may also be added to social-networking system 460 by a third-party through a “communication channel,” such as a newsfeed or stream.

In particular embodiments, social-networking system 460 may include a variety of servers, sub-systems, programs, modules, logs, and data stores. In particular embodiments, social-networking system 460 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 460 may also include suitable components such as network interfaces, security mechanisms, load balancers, failover servers, management-and-network-operations consoles, other suitable components, or any suitable combination thereof. In particular embodiments, social-networking system 460 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 460 to one or more client systems 430 or one or more third-party system 470 via network 410. The web server may include a mail server or other messaging functionality for receiving and routing messages between social-networking system 460 and one or more client systems 430. An API-request server may allow a third-party system 470 to access information from social-networking system 460 by calling one or more APIs. An action logger may be used to receive communications from a web server about a user's actions on or off social-networking system 460. In conjunction with the action log, a third-party-content-object log may be maintained of user exposures to third-party-content objects. A notification controller may provide information regarding content objects to a client system 430. Information may be pushed to a client system 430 as notifications, or information may be pulled from client system 430 responsive to a request received from client system 430. Authorization servers may be used to enforce one or more privacy settings of the users of social-networking system 460. A privacy setting of a user determines how particular information associated with a user can be shared. The authorization server may allow users to opt in to or opt out of having their actions logged by social-networking system 460 or shared with other systems (e.g., third-party system 470), such as, for example, by setting appropriate privacy settings. Third-party-content-object stores may be used to store content objects received from third parties, such as a third-party system 470. Location stores may be used for storing location information received from client systems 430 associated with users. Advertisement-pricing modules may combine social information, the current time, location information, or other suitable information to provide relevant advertisements, in the form of notifications, to a user.

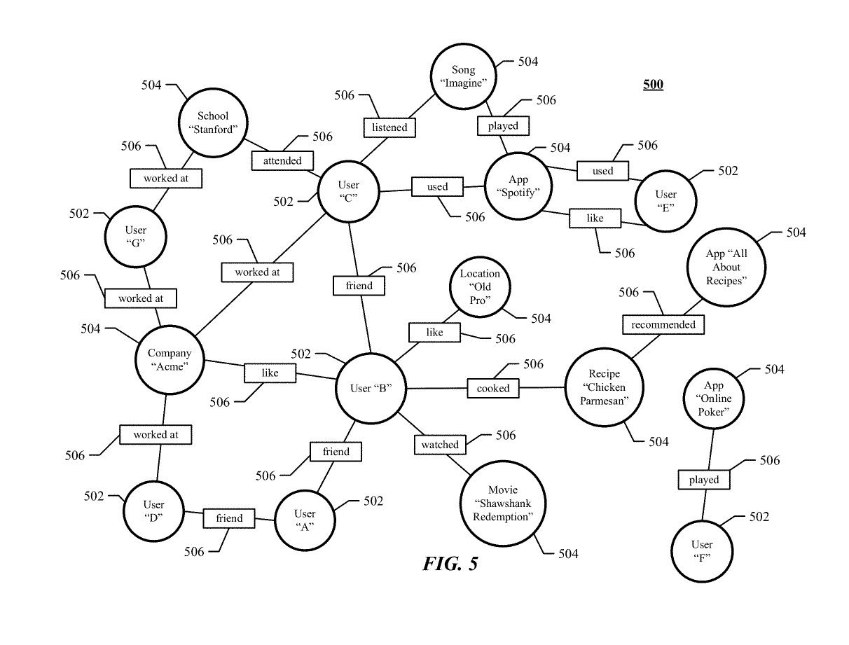

FIG. 5 illustrates example social graph 500. In particular embodiments, social-networking system 460 may store one or more social graphs 500 in one or more data stores. In particular embodiments, social graph 500 may include multiple nodes—which may include multiple user nodes 502 or multiple concept nodes 504—and multiple edges 506 connecting the nodes. Example social graph 500 illustrated in FIG. 5 is shown, for didactic purposes, in a two-dimensional visual map representation. In particular embodiments, a social-networking system 460, client system 430, or third-party system 470 may access social graph 500 and related social-graph information for suitable applications. The nodes and edges of social graph 500 may be stored as data objects, for example, in a data store (such as a social-graph database). Such a data store may include one or more searchable or queryable indexes of nodes or edges of social graph 500.

In particular embodiments, a user node 502 may correspond to a user of social-networking system 460. As an example and not by way of limitation, a user may be an individual (human user), an entity (e.g., an enterprise, business, or third-party application), or a group (e.g., of individuals or entities) that interacts or communicates with or over social-networking system 460. In particular embodiments, when a user registers for an account with social-networking system 460, social-networking system 460 may create a user node 502 corresponding to the user, and store the user node 502 in one or more data stores. Users and user nodes 502 described herein may, where appropriate, refer to registered users and user nodes 502 associated with registered users. In addition or as an alternative, users and user nodes 502 described herein may, where appropriate, refer to users that have not registered with social-networking system 460. In particular embodiments, a user node 502 may be associated with information provided by a user or information gathered by various systems, including social-networking system 460. As an example and not by way of limitation, a user may provide his or her name, profile picture, contact information, birth date, sex, marital status, family status, employment, education background, preferences, interests, or other demographic information. In particular embodiments, a user node 502 may be associated with one or more data objects corresponding to information associated with a user. In particular embodiments, a user node 502 may correspond to one or more webpages.

In particular embodiments, a concept node 504 may correspond to a concept. As an example and not by way of limitation, a concept may correspond to a place (such as, for example, a movie theater, restaurant, landmark, or city); a website (such as, for example, a website associated with social-network system 460 or a third-party website associated with a web-application server); an entity (such as, for example, a person, business, group, sports team, or celebrity); a resource (such as, for example, an audio file, video file, digital photo, text file, structured document, or application) which may be located within social-networking system 460 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 504 may be associated with information of a concept provided by a user or information gathered by various systems, including social-networking system 460. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 504 may be associated with one or more data objects corresponding to information associated with concept node 504. In particular embodiments, a concept node 504 may correspond to one or more webpages.

In particular embodiments, a node in social graph 500 may represent or be represented by a webpage (which may be referred to as a “profile page”). Profile pages may be hosted by or accessible to social-networking system 460. Profile pages may also be hosted on third-party websites associated with a third-party system 470. As an example and not by way of limitation, a profile page corresponding to a particular external webpage may be the particular external webpage and the profile page may correspond to a particular concept node 504. Profile pages may be viewable by all or a selected subset of other users. As an example and not by way of limitation, a user node 502 may have a corresponding user-profile page in which the corresponding user may add content, make declarations, or otherwise express himself or herself. As another example and not by way of limitation, a concept node 504 may have a corresponding concept-profile page in which one or more users may add content, make declarations, or express themselves, particularly in relation to the concept corresponding to concept node 504.

In particular embodiments, a concept node 504 may represent a third-party webpage or resource hosted by a third-party system 470. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 430 to send to social-networking system 460 a message indicating the user's action. In response to the message, social-networking system 460 may create an edge (e.g., a check-in-type edge) between a user node 502 corresponding to the user and a concept node 504 corresponding to the third-party webpage or resource and store edge 506 in one or more data stores.

In particular embodiments, a pair of nodes in social graph 500 may be connected to each other by one or more edges 506. An edge 506 connecting a pair of nodes may represent a relationship between the pair of nodes. In particular embodiments, an edge 506 may include or represent one or more data objects or attributes corresponding to the relationship between a pair of nodes. As an example and not by way of limitation, a first user may indicate that a second user is a “friend” of the first user. In response to this indication, social-networking system 460 may send a “friend request” to the second user. If the second user confirms the “friend request,” social-networking system 460 may create an edge 506 connecting the first user's user node 502 to the second user's user node 502 in social graph 500 and store edge 506 as social-graph information in one or more of data stores 464. In the example of FIG. 5, social graph 500 includes an edge 506 indicating a friend relation between user nodes 502 of user “A” and user “B” and an edge indicating a friend relation between user nodes 502 of user “C” and user “B.” Although this disclosure describes or illustrates particular edges 506 with particular attributes connecting particular user nodes 502, this disclosure contemplates any suitable edges 506 with any suitable attributes connecting user nodes 502. As an example and not by way of limitation, an edge 506 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 500 by one or more edges 506.

In particular embodiments, an edge 506 between a user node 502 and a concept node 504 may represent a particular action or activity performed by a user associated with user node 502 toward a concept associated with a concept node 504. As an example and not by way of limitation, as illustrated in FIG. 5, a user may “like,” “attended,” “played,” “listened,” “cooked,” “worked at,” or “watched” a concept, each of which may correspond to an edge type or subtype. A concept-profile page corresponding to a concept node 504 may include, for example, a selectable “check in” icon (such as, for example, a clickable “check in” icon) or a selectable “add to favorites” icon. Similarly, after a user clicks these icons, social-networking system 460 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 460 may create a “listened” edge 506 and a “used” edge (as illustrated in FIG. 5) between user nodes 502 corresponding to the user and concept nodes 504 corresponding to the song and application to indicate that the user listened to the song and used the application. Moreover, social-networking system 460 may create a “played” edge 506 (as illustrated in FIG. 5) between concept nodes 504 corresponding to the song and the application to indicate that the particular song was played by the particular application. In this case, “played” edge 506 corresponds to an action performed by an external application (SPOTIFY) on an external audio file (the song “Imagine”). Although this disclosure describes particular edges 506 with particular attributes connecting user nodes 502 and concept nodes 504, this disclosure contemplates any suitable edges 506 with any suitable attributes connecting user nodes 502 and concept nodes 504. Moreover, although this disclosure describes edges between a user node 502 and a concept node 504 representing a single relationship, this disclosure contemplates edges between a user node 502 and a concept node 504 representing one or more relationships. As an example and not by way of limitation, an edge 506 may represent both that a user likes and has used at a particular concept. Alternatively, another edge 506 may represent each type of relationship (or multiples of a single relationship) between a user node 502 and a concept node 504 (as illustrated in FIG. 5 between user node 502 for user “E” and concept node 504 for “SPOTIFY”).

In particular embodiments, social-networking system 460 may create an edge 506 between a user node 502 and a concept node 504 in social graph 500. As an example and not by way of limitation, a user viewing a concept-profile page (such as, for example, by using a web browser or a special-purpose application hosted by the user's client system 430) may indicate that he or she likes the concept represented by the concept node 504 by clicking or selecting a “Like” icon, which may cause the user's client system 430 to send to social-networking system 460 a message indicating the user's liking of the concept associated with the concept-profile page. In response to the message, social-networking system 460 may create an edge 506 between user node 502 associated with the user and concept node 504, as illustrated by “like” edge 506 between the user and concept node 504. In particular embodiments, social-networking system 460 may store an edge 506 in one or more data stores. In particular embodiments, an edge 506 may be automatically formed by social-networking system 460 in response to a particular user action. As an example and not by way of limitation, if a first user uploads a picture, watches a movie, or listens to a song, an edge 506 may be formed between user node 502 corresponding to the first user and concept nodes 504 corresponding to those concepts. Although this disclosure describes forming particular edges 506 in particular manners, this disclosure contemplates forming any suitable edges 506 in any suitable manner.

In particular embodiments, social-networking system 460 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 470 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 460 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 460 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 460 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 460 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 460 may calculate a coefficient based on a user's actions. Social-networking system 460 may monitor such actions on the online social network, on a third-party system 470, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 460 may calculate a coefficient based on the user's actions with particular types of content. The content may be associated with the online social network, a third-party system 470, or another suitable system. The content may include users, profile pages, posts, news stories, headlines, instant messages, chat room conversations, emails, advertisements, pictures, video, music, other suitable objects, or any combination thereof. Social-networking system 460 may analyze a user's actions to determine whether one or more of the actions indicate an affinity for subject matter, content, other users, and so forth. As an example and not by way of limitation, if a user frequently posts content related to “coffee” or variants thereof, social-networking system 460 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 460 may calculate a coefficient based on the type of relationship between particular objects. Referencing the social graph 500, social-networking system 460 may analyze the number and/or type of edges 506 connecting particular user nodes 502 and concept nodes 504 when calculating a coefficient. As an example and not by way of limitation, user nodes 502 that are connected by a spouse-type edge (representing that the two users are married) may be assigned a higher coefficient than a user nodes 502 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system 460 may determine that the user has a higher coefficient with respect to the first photo than the second photo because having a tagged-in-type relationship with content may be assigned a higher weight and/or rating than having a like-type relationship with content. In particular embodiments, social-networking system 460 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 460 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 500. As an example and not by way of limitation, social-graph entities that are closer in the social graph 500 (i.e., fewer degrees of separation) may have a higher coefficient than entities that are further apart in the social graph 500.

In particular embodiments, social-networking system 460 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 430 of the user). A first user may be more interested in other users or concepts that are closer to the first user. As an example and not by way of limitation, if a user is one mile from an airport and two miles from a gas station, social-networking system 460 may determine that the user has a higher coefficient for the airport than the gas station based on the proximity of the airport to the user.

In particular embodiments, social-networking system 460 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 460 may provide information that is relevant to user's interests and current circumstances, increasing the likelihood that they will find such information of interest. In particular embodiments, social-networking system 460 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 460 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 460 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 470 (e.g., via an API or other communication channel), or from another suitable system. In response to the request, social-networking system 460 may calculate the coefficient (or access the coefficient information if it has previously been calculated and stored). In particular embodiments, social-networking system 460 may measure an affinity with respect to a particular process. Different processes (both internal and external to the online social network) may request a coefficient for a particular object or set of objects. Social-networking system 460 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

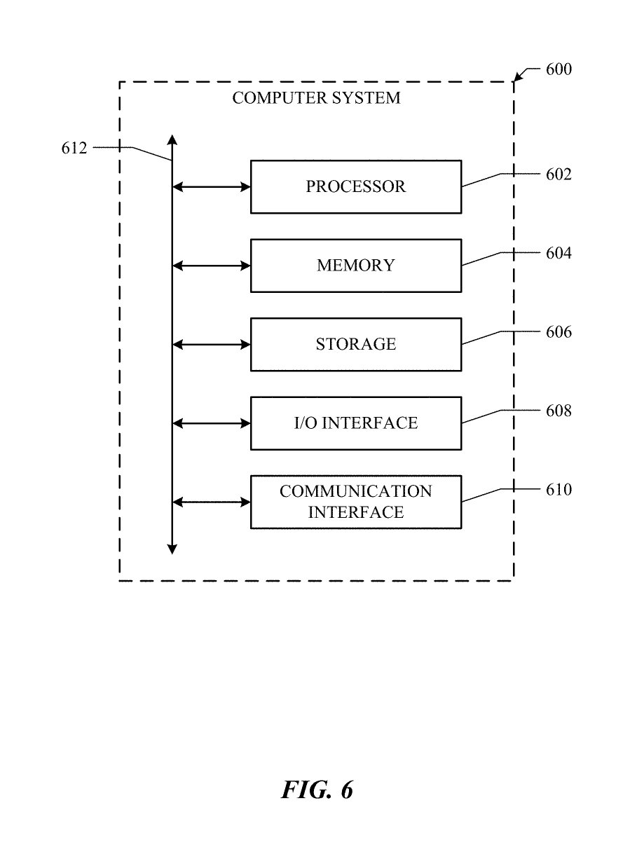

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system associated with an online social network:
receiving, from a first device associated with a first user of the online social network, a request to post content from a third-party system on the online social network;
generating, in response to the request to post, contextual information associated with the content, the contextual information comprising information indicative of the credibility of the content;
receiving a content request from a second device associated with a second user of the online social network;
determining that the content from the third-party system is to be presented to the second user in response to the content request; and
sending instructions configured to cause the second device to perform operations, comprising:
displaying the content with an indicator, the indicator indicating that contextual information is available for the content;
upon detecting a first interest indicator representing that the content is being viewed on the second device, transforming the indicator into a contextual highlight, the contextual highlight being based on a portion of the contextual information; and
upon detecting a second interest indicator representing user interest in the available contextual information, displaying the contextual information.

2. The method of claim 1, further comprising:
accessing information associated with the second user; and
determining, based on the information, that the second user is likely to engage with contextual information associated with content posted on the online social network.

3. The method of claim 1, wherein the displaying of the content comprises displaying an image from the third-party system, wherein the displayed indicator is included in an overlay positioned over the image so that a first portion of the indicator covers a portion of the image and a second portion of the indicator covers a portion of an area outside the image.

4. The method of claim 1, wherein the contextual information comprises one or more first credibility indicators retrieved from the third-party system and one or more second credibility indicators generated by the computing system associated with the online social network.

5. The method of claim 4, further comprising:
for each credibility indicator in the one or more first credibility indicators and the one or more second credibility indicators, generating a score that represents a level of significance of the credibility indicator in indicating whether the content is credible; and
selecting a selected credibility indicator from the one or more first credibility indicators and the one or more second credibility indicators based on the score associated with the selected credibility indicator;
wherein the contextual highlight comprises information associated with the selected credibility indicator.

6. The method of claim 4, further comprising:
retrieving information associated with the second user; and
selecting, based on the information associated with the second user, a selected credibility indicator that is likely to be of interest to the second user from the one or more first credibility indicators and the one or more second credibility indicators;
wherein the contextual highlight comprises information associated with the selected credibility indicator.

7. The method of claim 1, further comprising:
determining that the contextual information lacks a credibility indicator expected of credible contents;
wherein the contextual highlight comprises information indicating that the credibility indicator is lacking for the content.

8. The method of claim 1, further comprising:
determining a subject matter or issue associated with the content; and
identifying a second content posted on the online social network that is associated with the subject matter or issue, the second content being from a second third-party system different from the third-party system;
wherein the contextual information comprises the second content.

9. The method of claim 1, further comprising:
determining a subject matter or issue associated with the content;
determining a first perspective expressed in the content relating to the subject matter or issue; and
identifying a second content posted on the online social network that expresses a second perspective relating to the subject matter or issue, the second perspective being different from the first perspective;
wherein the contextual information comprises the second content.

10. The method of claim 1, further comprising:
retrieving records of instances of the content being shared by users of the online social network;
identifying geographic locations associated with the users associated with the instances; and
generating a geographic map depicting the identified geographic locations;
wherein the contextual information comprises the geographic map.

11. A system associated with an online social network, comprising: one or more processors and one or more computer-readable non-transitory storage media coupled to one or more of the processors, the one or more computer-readable non-transitory storage media comprising instructions operable when executed by one or more of the processors to cause the system to perform operations comprising:
receiving, from a first device associated with a first user of the online social network, a request to post content from a third-party system on the online social network;
generating, in response to the request to post, contextual information associated with the content, the contextual information comprising information indicative of the credibility of the content;
receiving a content request from a second device associated with a second user of the online social network;
determining that the content from the third-party system is to be presented to the second user in response to the content request; and
sending instructions configured to cause the second device to perform operations, comprising:
displaying the content with an indicator, the indicator indicating that contextual information is available for the content;
upon detecting a first interest indicator representing that the content is being viewed on the second device, transforming the indicator into a contextual highlight, the contextual highlight being based on a portion of the contextual information; and
upon detecting a second interest indicator representing user interest in the available contextual information, displaying the contextual information.

12. The system of claim 11, wherein the displaying of the content comprises displaying an image from the third-party system, wherein the displayed indicator is included in an overlay positioned over the image so that a first portion of the indicator covers a portion of the image and a second portion of the indicator covers a portion of an area outside the image.

13. The system of claim 11, wherein the contextual information comprises one or more first credibility indicators retrieved from the third-party system and one or more second credibility indicators generated by the computing system associated with the online social network.

14. The system of claim 13, wherein the processors are further operable when executing the instructions to perform operations comprising:
for each credibility indicator in the one or more first credibility indicators and the one or more second credibility indicators, generating a score that represents a level of significance of the credibility indicator in indicating whether the content is credible; and
selecting a selected credibility indicator from the one or more first credibility indicators and the one or more second credibility indicators based on the score associated with the selected credibility indicator;
wherein the contextual highlight comprises information associated with the selected credibility indicator.

15. The system of claim 13, wherein the processors are further operable when executing the instructions to perform operations comprising:
retrieving information associated with the second user; and
selecting, based on the information associated with the second user, a selected credibility indicator that is likely to be of interest to the second user from the one or more first credibility indicators and the one or more second credibility indicators;
wherein the contextual highlight comprises information associated with the selected credibility indicator.

16. One or more computer-readable non-transitory storage media embodying software that is operable when executed to cause one or more processors of a system associated with an online social network to perform operations comprising:
receiving, from a first device associated with a first user of the online social network, a request to post content from a third-party system on the online social network;
generating, in response to the request to post, contextual information associated with the content, the contextual information comprising information indicative of the credibility of the content;
receiving a content request from a second device associated with a second user of the online social network;
determining that the content from the third-party system is to be presented to the second user in response to the content request; and
sending instructions configured to cause the second device to perform operations, comprising:
displaying the content with an indicator, the indicator indicating that contextual information is available for the content;
upon detecting a first interest indicator representing that the content is being viewed on the second device, transforming the indicator into a contextual highlight, the contextual highlight being based on a portion of the contextual information; and
upon detecting a second interest indicator representing user interest in the available contextual information, displaying the contextual information.

17. The media of claim 16, wherein the displaying of the content comprises displaying an image from the third-party system, wherein the displayed indicator is included in an overlay positioned over the image so that a first portion of the indicator covers a portion of the image and a second portion of the indicator covers a portion of an area outside the image.

18. The media of claim 16, wherein the contextual information comprises one or more first credibility indicators retrieved from the third-party system and one or more second credibility indicators generated by the computing system associated with the online social network.

19. The media of claim 18, wherein the software is further operable when executed to cause the one or more processors to perform operations comprising:
for each credibility indicator in the one or more first credibility indicators and the one or more second credibility indicators, generating a score that represents a level of significance of the credibility indicator in indicating whether the content is credible; and
selecting a selected credibility indicator from the one or more first credibility indicators and the one or more second credibility indicators based on the score associated with the selected credibility indicator;
wherein the contextual highlight comprises information associated with the selected credibility indicator.

20. The media of claim 18, wherein the software is further operable when executed to cause the one or more processors to perform operations comprising:
retrieving information associated with the second user; and
selecting, based on the information associated with the second user, a selected credibility indicator that is likely to be of interest to the second user from the one or more first credibility indicators and the one or more second credibility indicators;
wherein the contextual highlight comprises information associated with the selected credibility indicator.
